(19) United States
(12) Patent Application Publication
(10) Pub. No.: US 2021/0394353 A1
(43) Pub. Date: Dec. 23, 2021

(54) Screwdriver Handle

(71) Applicant: Nigel Alexander Buchanan, Fife (GB)

(72) Inventor: Nigel Alexander Buchanan, Fife (GB)

(21) Appl. No.: 17/261,919

(22) PCT Filed: Jul. 22, 2019
(86) PCT No.: PCT/GB2019/000104

§ 371 Date: Jan. 21, 2021

(30) Foreign Application Priority Data
Jul. 20, 2018 (GB) 1811909.9

(51) Int. Cl. B25G 1/08; B25F 1/00; H02G 1/12; H01R 43/042

(52) U.S. Cl. CPC B25G 1/085; H01R 43/0421; H02G 1/1204; B25F 1/003

(57) ABSTRACT

A screwdriver, comprising a handle having an integral planar pivotal moving and fixed frame incorporating as required a robust wire cutting or stripping mechanism etc. The rigidity of the frames enhanced by their robust attachment within corresponding main and moving plastic over mouldings constituting the handle bodies, the main frame attached to the screwdriver shank. When closed, the handle profiles form the suitably ergonomic profile of a screwdriver handle. A storage chamber for example for interchangeable screwdriver bits can be formed within the handle interior. The wire stripping feature incorporates a method of setting the required length of insulation to be removed from the worked wire comprising of a setting wheel capable of rotational movement around an axle, retained within the main body handle parallel to the wire stripping profile. The setting wheel face incorporating differing depth faces from the wire stripping profiles.

### FIELD OF THE INVENTION

The invention relates to a screwdriver and a tool handle incorporating snips, wire-strippers, crimpers and other pliers like tools.

Many tools are stand-alone tools, with relatively simple functions. Such as the traditional screwdriver, which has a primary function of screwing, and the traditional wire stripper which has a primary function of stripping wires, the wire stripper normally further incorporating a wire cutting function as the wires to be stripped invariably require to be cut or trimmed to length. Whilst both tools are used in the connection of electrical wires they are normally independent of one another.

### BACKGROUND TO THE INVENTION

In operation, an electrician during installations and other functions requires to screw screws or connect wires. The tools generally used are a screwdriver, wire stripper, snips and occasionally pliers for the twisting of multiple wires together, whereas the wire stripper and snips can be usefully incorporated into a set of pliers, given the robust requirements of the snips and pliers no commercially available suitable professional tool incorporating all these functions into a screwdriver is in full production at this time. Furthermore given the differing sizes and types of screw heads that can be encountered, either several screwdrivers with differing head types (Flat, Pozidrive, Philips etc.) or a screwdriver with known suitable interchangeable head bits is the preferred option.

When the electrician or competent individual works on domestic, light industrial, automotive or any other “light” electrical jobs it would be far more convenient and time efficient to have one tool capable of many or all of these functions instead of constantly switching between the screwdriver, snips, wire stripper or pliers required to install or connect wires to their terminals. Especially in awkward, confined or high places where the inconvenience, bulk and weight of several tools can be acute, the electrician in most installations having to prepare and connect a lot of wires which can be very time consuming given the constant changing between the differing tools.

A further inconvenient and time consuming problem being the regulation of the length of wire stripped for connection within the chosen terminal. All but the most expensive or single use wire strippers have an adjustable means of determining the given length of insulation to be stripped from the worked wire. The operator usually judging by eye the correct length required, which in itself is time consuming. If the stripped wire is too long the live wire core can be dangerously exposed, if too short the wire core could have a dangerously insufficient electrical connection within its allotted terminal. At best the surplus end of the exposed wire core is snipped off or a further operation of the wire strippers is required in order to remove more insulation if the exposed wire core is too short.

US 2003/0150062 A1 and CN200957531Y disclose a set of pliers or wire strippers having a screwdriver blade within the extremity of one of its jaws, their use as anything but an emergency screwdriver is limited as the operation of the screwdriver function is extremely awkward.

US 2016/0094091 denotes a screwdriver with a wire stripper situated next to the screwdriver shaft, the stripper blade is within the handle and a sprung pressing plate with wire grooves within the pressing plate around the screwdriver shaft. In use the wire to be stripped is inserted into the pressing plate wire groove, the length of wire to be stripped judged by eye only, the pressing plate pressed urging the wire against the U shaped cutter within the adjoining handle, the wire insulation only being cut by approximately ⅔, the wire then being pulled in order to tear the remaining insulation to be stripped from the worked wire, the pressing plate requiring to remain pushed during this operation. This design is suitable for small diameter wires and occasional DIY (do it yourself) use given its limited and dexterous use. U.S. Pat. No. 9,450,388 is similar but the mechanism being situated within the top of the handle away from the shaft.

U.S. Pat. No. 9,138,880 discloses a screwdriver with a pocket with a hinged lid within the handle, the pocket has receiving means for securing a separate wire cutter and stripper within the pocket. During use, the wire stripper contained within the pocket is operated by the pocket hinged cover bearing down on the incumbent wire stripping frame in order to cut the wire insulation so it can be removed from the worked wire, there is no shown means of regulating the length of insulation being removed, the operator merely judging by eye. In use the hinged cover is subject to extreme pressure and wear especially when the device is utilized as wire cutting snips, the device as illustrated would be unfit for the purpose of everyday wire cutting. The device is both complex and expensive to manufacture, especially the means to adequately secure the wire cutting/stripping component within the pocket, the wire stripping component being produced separately. The hinged cover or “moving member” being a separate component from the “first clamp body” with its own separate “second pivot shaft”, this shaft and associated moving member being subject to considerable pressure during any wire snipping action.

The prior art use is that of an emergency or occasional use tool with limited wire cutting or alternately screwdriver use with no measurement or calibration of the required length of insulation to be stripped.

It is an object of the present invention to provide an uncomplicated robust tool that can be usefully used to provide both a screwdriver and wire stripper with wire cutting capabilities equivalent to that of two separate tools in one structure, capable of everyday use, whilst being simple and less expensive to manufacture. It is a further object of the present invention to at least partially alleviate the above mentioned disadvantages, or to provide an alternative to existing products.

### SUMMARY OF THE INVENTION

In a first aspect, the present invention provides a screwdriver, comprising a handle having an integral robust wire snipping and stripping mechanism within the handle parts, said handle having an integral, robust, generally planar main frame with the screwdriver shaft preferably securely attached or securely slotted into the main frame. The screwdriver shaft and the main frame being further plastic over moulded, glued or generally securely affixed within the main handle outer body. A further moving handle with an internal robust planar moving frame is robustly pivotally connected to the main frame through corresponding pivot holes by a suitable pivot pin. The moving frame being further, plastic over moulded, glued or generally securely affixed within the moving handle body. When the moving handle is pivotally closed, its outer profile forms with the main handle outer profile the suitably ergonomic profile of a screwdriver handle. When the moving handle is opened it exposes the wire stripping and cutting profiles formed within the corresponding leading edges of the opposing main frame and moving frame, these cutting and stripping faces are correctly positioned such that as to take the form of known profiles of cutters or wire strippers similar to those within known pliers and such. The closure of the moving handle when a suitable wire size is placed at right angles to the chosen cutting or wire stripping blades at the chosen length of insulation to be removed performs the required function similar to that of known wire cutting and stripping pliers incorporating this function. The resulting cutting or stripping mechanism having a similar useable cutting leverage and robustness, to that of a normal pair of electrical cutting, stripping or crimping pliers. The rigidity of the main and moving frames are usefully enhanced by their robust attachment within their corresponding plastic mouldings constituting the corresponding main and moving handle bodies, the frames in best practice having further strategically placed through holes, through which the injection over moulded handle plastics can form robust locators.

In a preferred embodiment the integral rigid metal main frame is securely plastic over moulded within the main handle, the main frame in best practise having a suitable profile and through-hole locators in order to enhance the securing of the plastic handle moulding to its corresponding metal main frame.

In a further preferred embodiment the moving handle further has a storage chamber formed within its inner underside profile. A further useable recess or storage chamber is formed within the main handle interior.

In a further preferred embodiment a spare screwdriver bit holder or alternately a spare setting wheel holder is suitably attached to the moving handle frame in order to conveniently provide a method of storing further screwdriver blade types, setting wheels or other required spares or tools that the operator might require.

In an even further preferred embodiment the chosen screwdriver shaft type is securely attached to the main frame either by welding or such or by a known slot type engagement.

In an even further preferred embodiment the secondary moving frame is pivotally attached to the main frame by a suitable pivot pin through corresponding pivot holes. In manufacture it is advantageous to assemble the main and moving handles separately and install a screw type pivot pin through the corresponding pivot pin holes to these built portions as part of the final assembly.

In an even further preferred embodiment the main and secondary moving frame cutting or stripping profile leading edges move against each other in a manner similar to that of conventional scissors.

In an even further preferred embodiment the cutting or stripping profiles are designed to abut instead of shear.

In an even further preferred embodiment the plastic moulded main handle incorporating the main frame is preferably configured such that a useable recess or storage chamber is formed within the handle interior without impairing the handle construction integrity.

In a further preferred embodiment there are gripping profiles, similar to pliers gripping profiles, incorporated adjacent or instead off the cutting or stripping profiles within the main and moving frame leading edges which can be for example be utilized to grip and twist together a plurality of wire cores prior to connection within their allotted terminal. As the gripping profiles in best practice should close generally parallel to one another during operational use, a further stratum or suitably placed extra laminate is required attached to either the main frame or moving frame. In a further preferred embodiment there are known crimping profiles suitably incorporated into the working faces of the main and moving frames for the useful crimping of known electrical crimps or installation of known connectors. As the crimping faces in best practice should close generally parallel to one another during operational use, in order to perform their operation in the optimum manner, a further stratum or suitably placed extra laminate is required attached to either the main frame or moving frame.

In an even further preferred embodiment the wire stripping apparatus incorporates a method of setting the required length of insulation to be removed from the worked wire core.

In the preferred embodiment the adjustment is attained by a setting wheel capable of rotational movement around a generally central axis, retained within the main body handle generally parallel to the wire stripping profiles incorporated within the main frame. The setting wheel face opposite the wire stripping profiles is usefully sectioned into various portions having differing depths from the wire stripping profiles. The particular depths of the wheel surface from the wire stripping blades corresponding to the particular length of stripped insulation from the wire core required. The operator merely projects the wire to be stripped into the corresponding groove of the wire size to be stripped, until the wire end abuts the wheel face portion set to the prearranged depth setting, the operator therefore has an efficient, repeatable method of determining the length of insulation being stripped.

In the even further preferred embodiment the setting wheel is replaceable if required with other wheels with differing depths according to the requirements of the particular wire insulation stripping length needed.

In the even further preferred embodiment the setting wheel usefully incorporates a cut out section which usefully allows the stripped wire to project to any length through the cut out section thereby allowing unrestricted wire stripping lengths if required.

In the further preferred embodiment the interchangeable setting wheel or wheels can be conveniently stored within the handle cavity.

In the even further preferred embodiment the setting wheel usefully has a gripping circumferential profile as an aid to the operator adjustments.

In the even further preferred embodiment the setting wheel has a means of impairing its rotational movement once set by the operator. In one example this could consist of a rubber O-ring suitably compressed between the setting wheel axis or axle and its adjacent housing.

In the even further preferred embodiment the setting wheel preferably has an appropriate legend or markers detailing the size or otherwise of the corresponding wire insulation length setting used. The calibration can also correspond to an appropriate marker within the screwdriver periphery.

In a further preferred embodiment the setting wheel can be incorporated into further wire stripping tools which do not also include a screwdriver function.

In a further preferred embodiment a resilient member or members are incorporated between the fixed handle and the moving handle such as to provide a resilient opening means whereas when the moving handle is unlocked and de-operated the moving handle will automatically attain the open position ready for use.

In the further preferred embodiment the moving handle and fixed handle incorporate corresponding stops in order to provide a means of providing both the optimum and maximum safe opening position of the moving handle relative to the fixed handle.

In a further preferred embodiment a further handle top portion furthest from the screwdriver shank is capable of restrained longitudinal movement preferably against a resilient member, in order that when the handle top portion is pulled outwards from the main handle, against its incumbent spring, it is capable of being rotated from one locked rotational position to another. The said handle top further incorporates at least one notch which in the first said top portion rotational position corresponds with the position of a catch within the distil end of the moving handle, which usefully allows the moving handle to be removed or operated back into the fixed handle portion as required when the catch and notch are aligned and the catch is free to traverse within the notch profile. When the moving handle portion requires to be locked in its closed position relative to the fixed handle, the moving handle is first closed against the fixed handle portion, the handle top portion is then pulled from the main handle portion against its closure spring enough to allow access to a further guide face between the open and closed locking positions and rotated as required into the second locked position, the said catch on the outer end of the moving handle now corresponding to a further locking face within the handle top portion thereby retaining the moving handle locked against the fixed handle portion. In best practice the rotational movement once the top portion is pulled against its closure spring is restricted to that of any of the open or closed locking positions and the guide face between them.

In a further preferred embodiment or as an alternative to fixed screwdriver bit blades the screwdriver moving handle, opposite the screwdriver shank has a bit holder incorporated into the underside of the moving handle grip face, preferably the bit holder is attached by known means to the moving handle frame. The moving handle when open allows access to the stored bits mounted upon the said bit holder. Ready access to differing screwdriver blade types is an advantage when working remotely from a stocked toolbox. The chosen stored known screwdriver bits being interchangeable as required into the known bit drive incorporated within the distil end of the screwdriver shank.

In a further preferred embodiment the present invention does not incorporate a screwdriver function. Only the wire stripping, cutting, crimping, outer insulation sleeve removal, wire installation, crimping, pliers or gripping functions are utilized or any desired combination of the functions required.

### A Marshalling of Reference Numerals Utilized in the Drawings

Following is a listing of the components used in the best mode preferred embodiment and alternative embodiments. For the ready reference of the reader the reference numerals have been arranged in ascending numerical order.

1/Screwdriver
200/Handle Portion
201/Main Handle Body
202/Main Handle Outer Profile
203/Main Handle Inner Profile
204/Main Handle Frame Recess
205/Main Handle Storage Chamber
206/Main Handle Setting Wheel Recess
207/Main Handle Setting Wheel Marker
208/Main Handle Top Face
209/Main Handle Top Portion Shaft
210/Main Handle Shaft Retainer Profile
211/Main Handle Pivot Pin Holes
212/Main Handle Stop Face
213/Main Handle Wire Recess
214/Main Handle Wire Size Groove
215/Moving Handle Body
216/Moving Handle Outer Profile
217/Moving Handle Inner Profile
218/Moving Handle Plastic Moulding
219/Moving Handle Catch
220/Moving Handle Stop Face
221/Moving Handle Wire Recess
223/Moving Handle Storage Chamber
224/Moving Handle Outer End
225/Moving Handle Frame Recess
226/Moving Handle Locating Protrusions
227/Moving Handle Pivot Pin Access Hole
228/Main Handle Top Locating Projections
229/Main Handle Moving Handle Locator
230/Setting Wheel Axle Pin Hole
231/Main Handle Plastic Moulding
300/Main Frame
301/Main Frame Leading Edge
302/Main Frame Cutting Face
303/Main Frame Stripping Face
304/Main Frame Gripping Face
305/Main Frame Crimping Face
306/Main Frame Moulding Through Holes
307/Main Frame Pivot Pin Hole
308/Main Frame Extra Laminate
309/Main Frame Extra Laminate Rivets
310/Main Frame Rivet Holes
311/Main Frame Screwdriver Shank Attachment Slot
400/Moving Frame
401/Moving Frame Leading Edge
402/Moving Frame Cutting Face
403/Moving Frame Stripping Face
404/Moving Frame Pliers Face
405/Moving Frame Crimping Face
406/Moving Frame Moulding Through Holes
407/Moving Frame Pivot Pin Hole
408/Moving Frame Bit Holder Hole
409/Pivot Pin
410/Moving Frame Catch
500/Screwdriver Shank
501/Screwdriver Operating Blade
502/Screwdriver Bit Holder
503/Screwdriver Bit Storage Portion
600/Setting Wheel
601/Setting Wheel Face
602/Setting Wheel Differing Depth Portions
603/Setting Wheel Cut-Out Portion
604/Setting Wheel Friction Portion
605/Setting Wheel Size Marker
606/Setting Wheel Axle Hole
607/Setting Wheel Gripping Profile
608/Setting Wheel Axle Pin
609/Setting Wheel Friction Portion Recess
700/Handle Top Portion
701/Retaining Shaft Bore
702/Spring Recess
703/Open Notch
704/Locking Face
705/Cap
706/Guide Face
707/Closed Locking Recess
708/Retainer Clip
709/Open Locking Recess
800/Main Spring
801/Top Portion Spring
900/Wire
901/Wire Core
902/Wire Insulation
903/Wire End

### BRIEF DESCRIPTION OF THE DRAWINGS

A full and enabling disclosure of the invention including the best mode thereof, directed to one of ordinary skill in the art, is set forth in the specification, which makes reference to the appended drawings, in which:

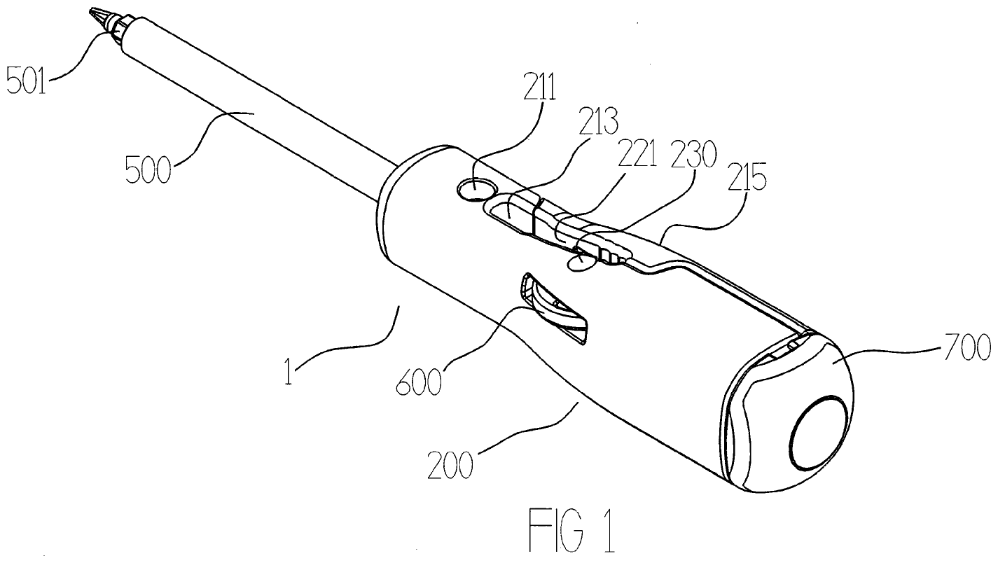

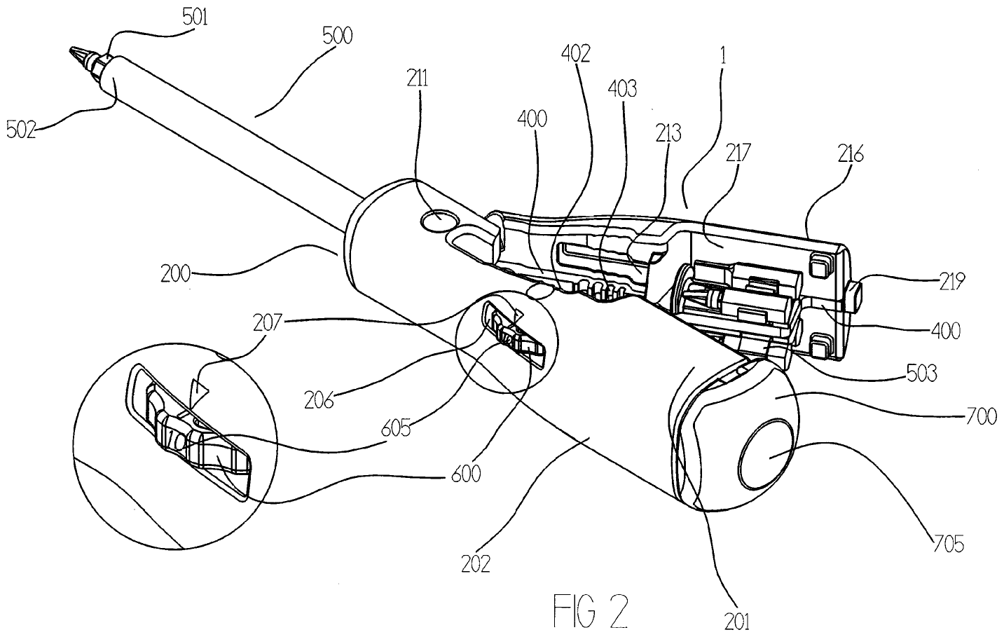

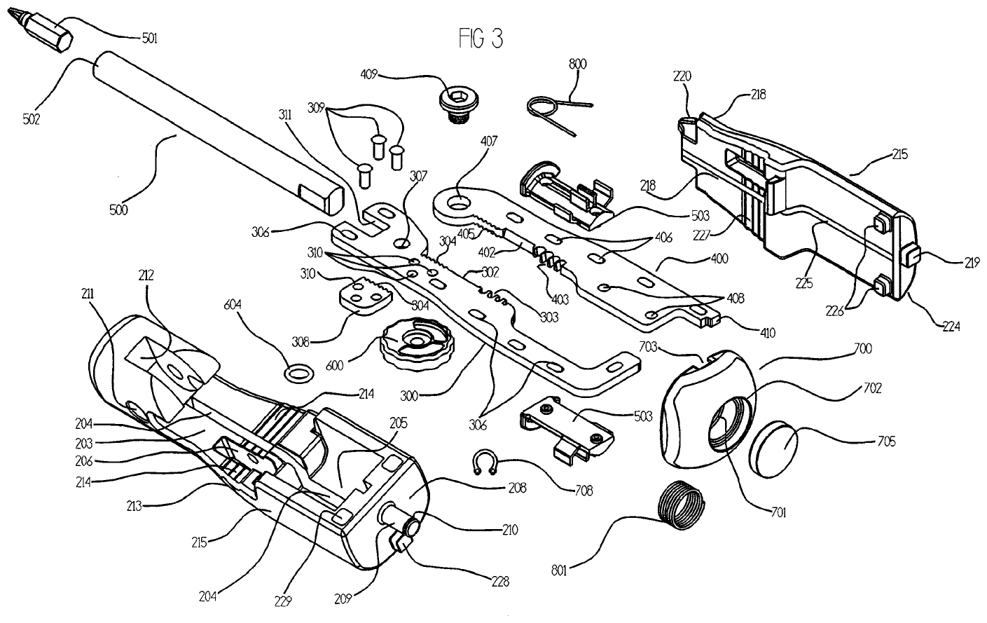

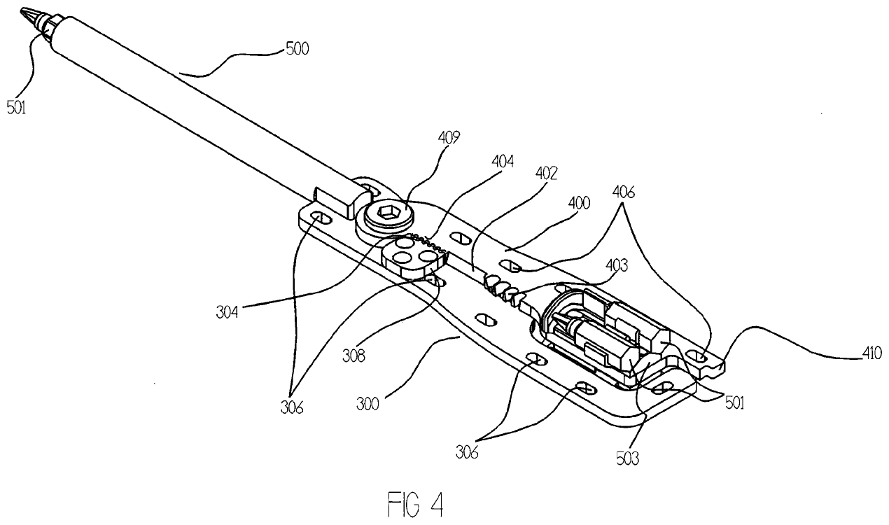

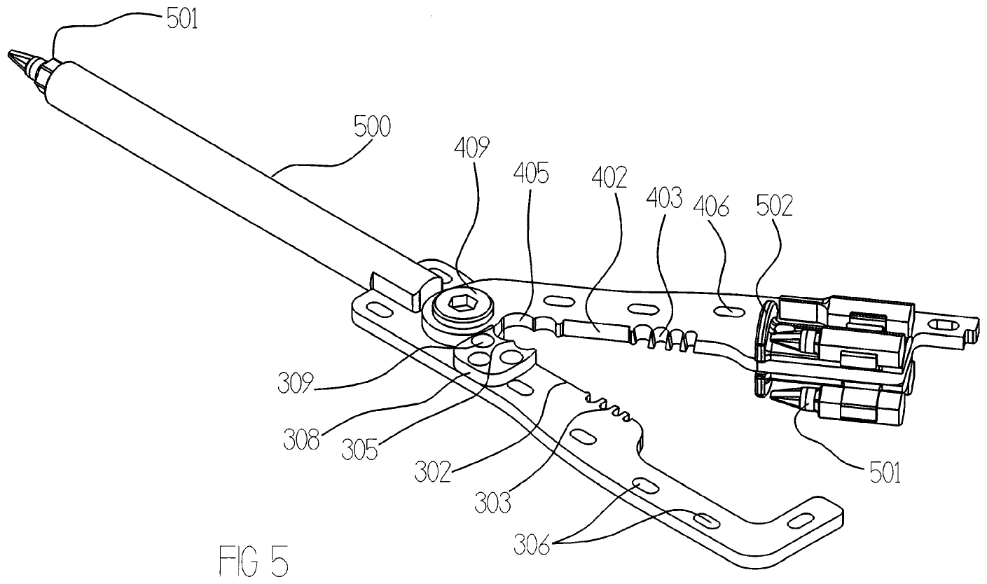

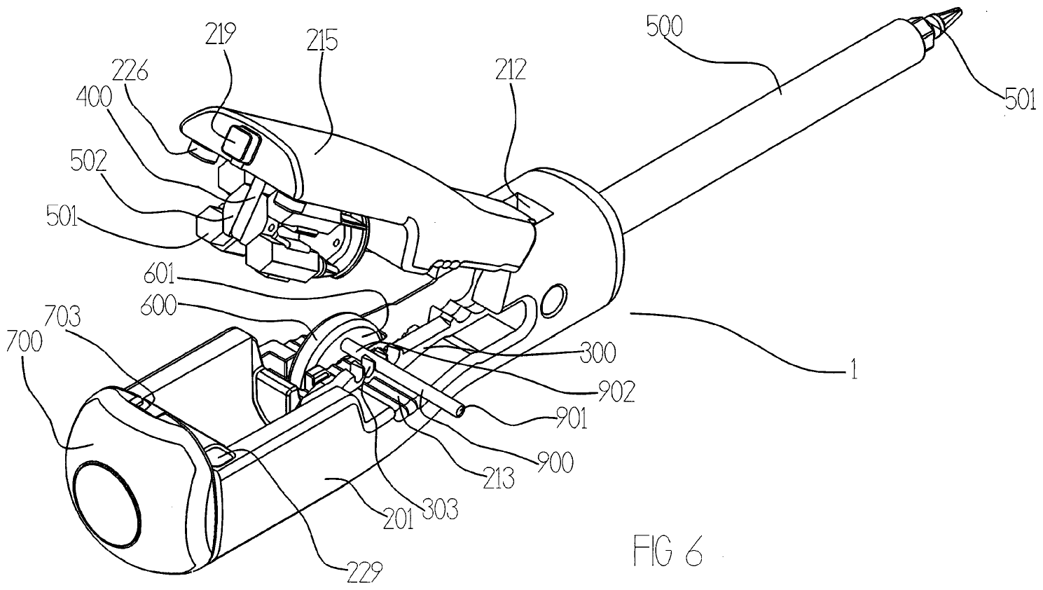

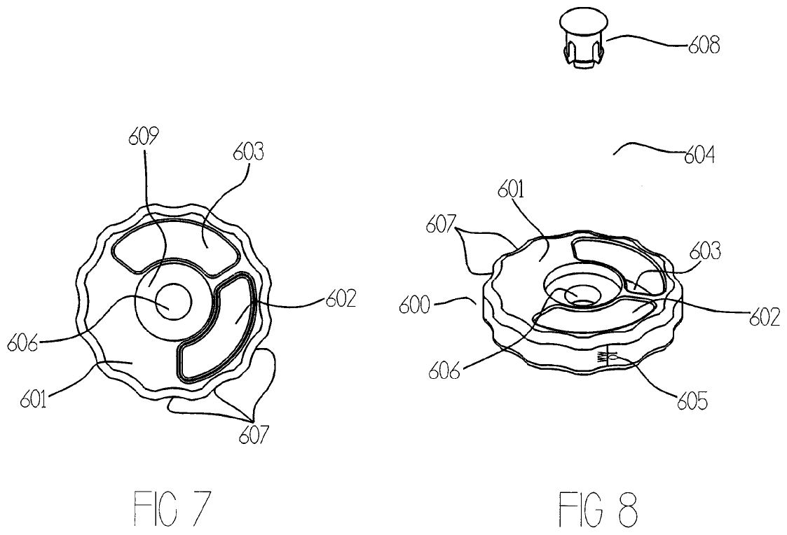

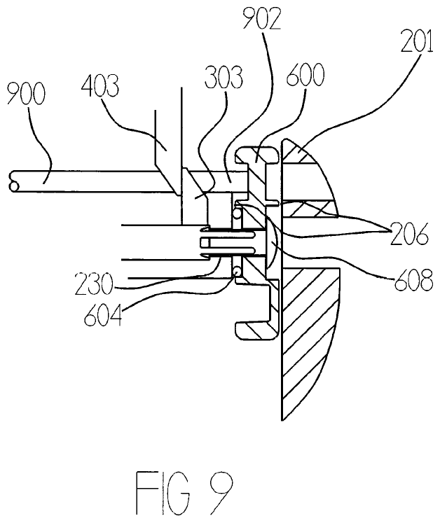

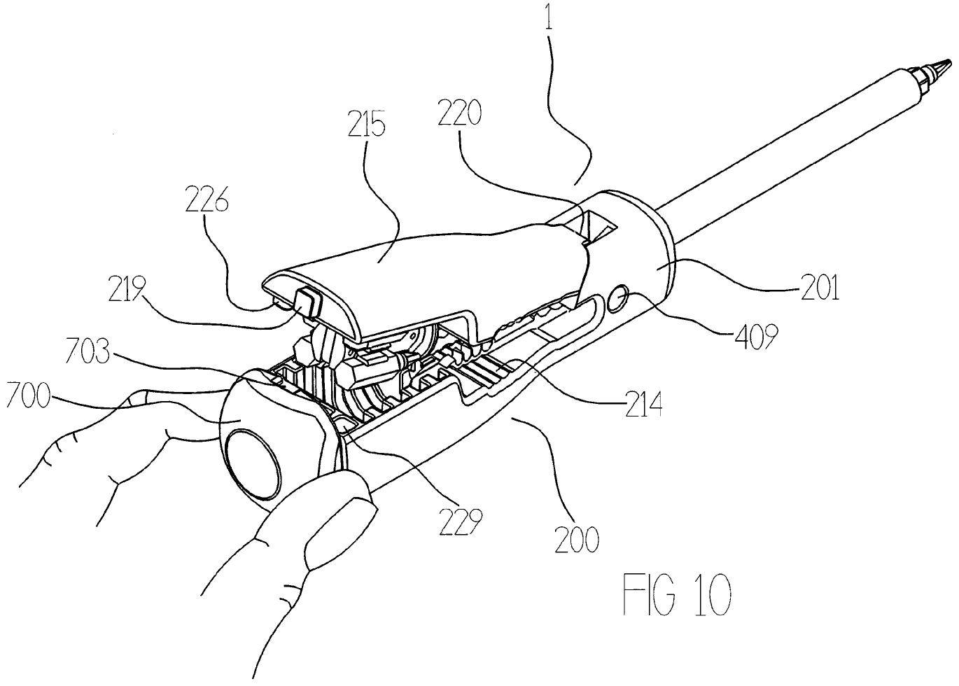

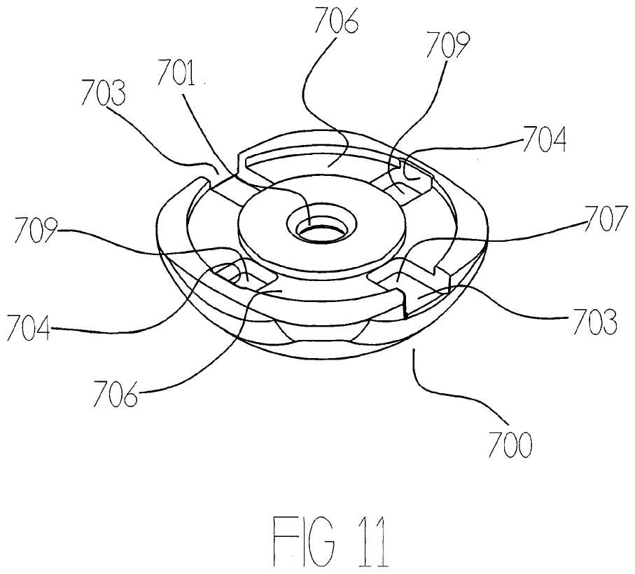

FIG. 1 is a perspective view of a screwdriver, the moving handle shown closed.

FIG. 2 is a perspective view of the screwdriver, the moving handle illustrated open.

FIG. 3 is an exploded perspective view of the screwdriver.

FIG. 4 is a perspective view of the screwdriver skeleton, illustrating the integral main and moving rigid frames closed relative to one another.

FIG. 5 is a perspective view of the screwdriver skeleton, illustrating the integral main and moving rigid frames open relative to one another.

FIG. 6 is a perspective view of the screwdriver, the moving handle illustrated open. A wire prior to being stripped of its chosen insulation length is displayed abutting the chosen depth of setting wheel face.

FIG. 7 is a top view of the setting wheel shown separately.

FIG. 8 is a perspective view of the setting wheel shown separately.

FIG. 9 is a side section partial view of the setting wheel, and the main, moving frame stripping faces within the main and moving handle adjoining portions engaging the wire insulation at the designated length from the wire end, illustrating the method of using the setting wheel to fix the length of insulation to be stripped from the worked wire.

FIG. 10 is a perspective view of the screwdriver, the moving handle illustrated being unlocked from the main handle.

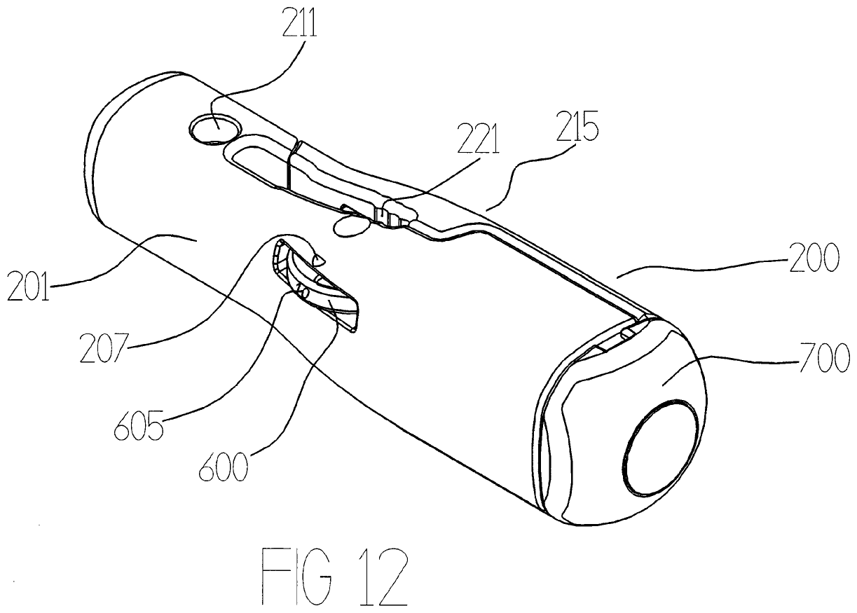

FIG. 11 is a perspective view of the handle top portion.

FIG. 12 is a perspective view of a stand-alone handle portion without the screwdriver shank.

### DETAILED DESCRIPTION OF THE PREFERRED EMBODIMENTS

As required, detailed embodiments of the invention are disclosed herein. However, it is to be understood that the disclosed embodiments are merely examples of the invention that may be embodied in various forms. The drawings are not necessarily to scale, as some of the features may be exaggerated to show details of particular components. Therefore, specific structural and functional details disclosed herein are not to be interpreted as limiting, but merely as a basis for the claims and as one skilled in the art to variously employ the invention.

The embodiments described herewith will be described with reference to FIGS. 1 to 12, in accordance with the invention there is provided a screwdriver 1 comprising a handle 200 having an integral, robust, generally planar main frame 300 with the screwdriver shaft 500 preferably securely attached. The screwdriver shaft 500 and the main frame 300 being further moulded 231, glued or generally securely affixed within the main handle body 201. A further moving handle body 215 with an internal robust planar secondary moving frame 400 is pivotally connected to the main frame 300 through corresponding pivot holes 307, 407 by a suitable pivot pin 409. The moving frame 400 having being further, moulded 218, glued or generally securely affixed within the moving handle body 215. When the moving handle 215 is pivotally closed, its outer profile 216 forms with the main handle outer profile 202 the suitably ergonomic profile of a screwdriver handle 200. When the moving handle 215 is opened it exposes the wire stripping faces 303, 403 and cutting faces 302, 402 formed within the corresponding leading edges 301, 401 of the opposing main frame 300 and moving frame 400, these cutting 302, 402 and stripping faces 303, 403 are correctly positioned such that as to take the form of known profiles of cutters or wire strippers similar to those within known pliers and such (not shown). The closure of the moving handle 215 when a suitable wire 900 size is placed at right angles to the chosen cutting 302, 402 or wire stripping blades 303, 403 at the chosen length of insulation 902 to be removed performs the required function similar to that of known wire cutting and stripping pliers (not shown) incorporating this function. The resulting cutting 302, 402 or stripping 303, 403 mechanism, having a similar useable cutting 302, 402 leverage and robustness, to that of a typical pair of normal electrical cutting, stripping or crimping pliers (not shown). The rigidity of the main 300 and secondary moving frame 400 being enhanced by their robust attachment within their corresponding plastic over mouldings 231, 218 constituting the corresponding main 201 and moving handle 215 bodies, the frames 300, 400 in best practice having further strategically placed through holes 306, 406, through which the injected moulded handle plastics 231, 218 can form robust locators. A resilient member or members 800 are incorporated between the main handle 201 and the moving handle 215 such as to provide a resilient opening means 800 whereas when the moving handle 215 is unlocked and de-operated the moving handle 215 will automatically attain the open position ready for use. The moving handle body 215 and fixed handle body 201 incorporate corresponding stops 220, 212 in order to provide a means of providing the optimum or maximum safe opening position of the moving handle 215 relative to the fixed main handle 201.

FIGS. 4 and 5 illustrate the internals of the handle portion 200, denoting the main and moving frames 300, 400 pivotally attached to one another by a suitable pivot pin 409 through corresponding pivot holes 307, 407. In an even further preferred embodiment the main and secondary moving frame cutting 302, 402 or stripping profiles 303, 403 leading edges 301, 401 move against each other in a manner similar to that of conventional scissors, the pivot pin 409 length is preferably adjustable in that it can be used in service to tighten the surface to surface gap of the main frame 300 against the secondary frame 400. The screwdriver shank 500 in best practice being robustly attached to the said main frame 300 by welding or such or alternately attached using known interlocking profiles. The said main frame 300 having an appropriate attachment slot 311 for the positional engagement of the screwdriver shank 500 as further illustrated in FIG. 3.

FIG. 4 shows a further iteration incorporating gripping profiles 304, 404, similar to known pliers gripping profiles, preferably incorporated adjacent the cutting 302, 402 or stripping faces 303, 403 within the main and secondary moving frame leading edges 301, 401 which can be for example be utilized to grip and twist together a plurality of wire cores 901 prior to connection within their allotted known terminal. As the gripping profiles 304, 404 in best practice require too close generally parallel to one another during operational use, a further stratum or suitably placed extra laminate 308 incorporating a similar gripping face 308 is required, attached to either the main frame 300 or moving frame 400 using rivets 309 through corresponding rivet holes 310 or any other known attachment means. FIG. 5 illustrates an optional crimping face 305, 405 requiring a similarly placed and mounted extra laminate 308 in order to perform its operation in the optimum manner.

FIGS. 2, 3, 6, 7, 8 and 9 illustrate an even further preferred embodiment whereas the wire stripping feature 303, 403 incorporates a method of setting the required length of insulation 902 to be removed from the worked wire core 901. Whereas the mechanism comprises of a setting wheel 600 capable of rotational movement around a generally central axle pin 608, retained within the main handle body axle pin holes 230 generally parallel to the wire stripping profiles 303 incorporated within the main frame 300. The setting wheel face 601 opposite the wire stripping profiles 303 is usefully sectioned into various portions having differing depths 602 from the wire stripping profiles 303. The particular depths of the wheel surface 601 from the wire stripping blades 303, 403 corresponding to the particular length of stripped insulation 902 from the wire core 901 required. The operator merely projects the wire 900 to be stripped into the corresponding wire size groove 214 of the wire 900 size to be stripped, until the wire end 905 abuts the wheel 601 face portion 602 set to the pre-arranged depth setting, the operator therefore has an efficient, repeatable method of determining the length of insulation 902 being stripped. The setting wheel 600 can further usefully incorporate a cut out section 603 which usefully allows the wire to be stripped 900 to project to any length through the cut out section 603 thereby allowing unrestricted wire 900 stripping lengths if required. As shown in FIG. 2 the setting wheel 600 usefully has a gripping circumferential profile 607 as an aid to the operator adjustments. The setting wheel 600 further incorporates a means of impairing its rotational movement once set by the operator. In one example this could consist of a rubber O-ring 604 suitably compressed between the setting wheel axis or axle 608 and its adjacent housing 206.

The setting wheel preferably has an appropriate legend or markers 605 detailing the size or otherwise of the corresponding wire insulation 902 length setting used. The calibration can also correspond to an appropriate marker 207 within the screwdriver periphery 202.

The setting wheel 600 is replaceable if required with other wheels 600 with differing depths 602 according to the requirements of the particular wire insulation 902 stripping length required. Further interchangeable setting wheel or wheels could be stored in the storage chamber 205, 223 if so configured.

FIGS. 2, 5, 6 and 10 denotes the screwdriver 1 whereas in FIG. 2 the moving handle 215 is shown in the open position illustrating a useful storage chamber 223 formed within the moving handle body 215 inner profile 217. A corresponding useable recess or storage chamber is further 205 formed within the main handle interior 203. FIGS. 2 and 6 further show a bit storage portion 503 attached to the moving frame 400 by known means. FIGS. 2, 6 and 10 even further shows operating blades 501 clipped into the said bit storage portion 503. It is obvious that the resultant storage chamber 205, 223 could be reconfigured instead for the storage of many known small tools or spare parts such as further setting wheels 600 having differing depth portions 602.

FIG. 1, 3 and in particular FIGS. 10 and 11 illustrate a handle top portion 700 furthest from the screwdriver shank 500 capable of restrained longitudinal movement preferably against a resilient member 801, in order that when the handle top portion 700 is pulled outwards from the main handle 201, against its incumbent spring 801, it is capable of being rotated from one locked rotational position to another. Comprising a retaining shaft bore 701, a spring recess 702, a top portion spring 801 corresponding to the main handle top face 208, top portion shaft 209, retainer profile 210 and cap 705. The said handle top 700 further incorporates at least one open notch 703 wherein when the open said top portion 700 rotational position corresponds with the position of a catch 219 within the distil or outer end 224 of the moving handle 215, usefully allowing the moving handle 215 to be swivelled out or operated back into the fixed main handle body 201 as required when the catch 219 and notch 703 are aligned and the catch 219 is free to traverse within the notch 703 profile. When the moving handle portion 215 requires to be locked in its closed position relative to the fixed handle 201, the moving handle 215 is first closed against the fixed handle portion 201, the handle top portion 700 is then pulled from the main handle portion 201 against its closure spring 801 enough to allow access to the guide face 706 between the open 709 and closed locking recess 707 positions and rotated as required into the locked recess position 707, the said catch 219 on the outer end 224 of the moving handle 215 now corresponding to a locking face 704 within the handle top portion 700 thereby ensuring the moving handle 215 remains locked against the fixed handle portion 201. In best practice the rotational movement once the top portion 700 is pulled against its closure spring 801 is restricted to that of the closed 707 and open 709 locking positions and the guide face 706 between them.

FIG. 12 further illustrates the invention 1, whereas the screwdriver shaft 500 (not shown) is not utilized.

1. A screwdriver handle comprising:
a generally planar main frame securely fixed within a main handle body;
a planar secondary moving frame pivotally connected to the main frame by a pivot pin, the moving frame securely fixed within a moving handle body,
wherein the moving handle body is pivotable relative to the main handle body between a closed position and an open position and when in said closed position said moving handle body, and
wherein when said moving handle body is in said closed position said moving handle body and main handle body are in adjoining relationship to cooperably define an outer profile of the screwdriver handle.

2. The screwdriver handle of claim 1, wherein the lateral rigidity of the integral rigid metal main frame and secondary moving frames is greatly enhanced by their robust attachment within their corresponding plastic mouldings constituting the corresponding main and moving handle bodies, the said frames in best practice having further strategically placed through holes, through which the injected over moulded handle plastics can form robust locators.

3. The screwdriver handle of claim 1 or 2 wherein the pivot pin extends through respective pivot holes provided in said main frame and said secondary moving frame.

4. The screwdriver handle of claim 1, 2 or 3,
wherein said main frame has a first edge provided with first wire cutting and stripping faces and said secondary moving frame has a second edge disposed opposite said first edge and provided with second wire cutting and stripping faces, and
wherein, in use, when said moving handle body is in said open position a wire can be inserted between said first and second wire cutting and stripping faces and when said moving handle is moved towards said closed position said first and second wire cutting and stripping faces cooperate to cut or strip said wire.

5. The screwdriver handle of claim 4, wherein the main frame and secondary moving frame are disposed in respective planes and when said moving handle is in said closed position, a portion of said secondary moving frame including said second wire cutting and stripping faces overlies said main frame.

6. The screwdriver handle of claim 4 or 5,
wherein the first edge of said main frame is provided with a first gripping profile and the second edge of the secondary moving frame comprises a second gripping profile cooperable with said first gripping profile when said moving handle body is moved towards said closed position, and
wherein a body defining third gripping profile is secured to one of said main frame and secondary moving frame such that said third gripping profile forms an extension of the respective gripping profile of the respective frame.

7. The screwdriver handle of claim 6, wherein the main frame and secondary moving frame gripping, crimping, cutting or stripping profiles are designed to alternately abut instead of shear.

8. The screwdriver handle of any one of claims 4 to 7, further comprising a depth setting wheel carried by said main handle body and having a depth setting face facing said first wire stripping faces, said depth setting face comprising at least a first depth setting face portion and a second depth setting face portion disposed closer to said main frame than said first depth setting face,
wherein, in use, a user can rotate said depth setting wheel to selectively bring said first and second depth setting face portions into a depth setting position in which the depth setting face portion is positioned to limit insertion of a leading end of a wire through said first wire stripping faces to set respective insertion depths.

9. The screw driver of claim 8, wherein the setting wheel further comprising a through-hole through which said leading end can pass unopposed.

10. The screwdriver handle of claim 9, wherein in said depth setting wheel is removable and further comprising a second depth setting wheel comprising at least a third depth setting face portion whereby said depth setting wheels are operable to define at least three insertion depths.

11. The screwdriver handle of any one of the preceding claims, wherein said main handle body an define a storage chamber and said secondary moving frame is provided with a screwdriver bit carrier to carry at least one screwdriver bit stored in said storage chamber when said moving handle body is in said closed position.

12. The apparatus of claim 11, wherein the handle top portion furthest from the screwdriver shank is capable of restrained longitudinal movement preferably against a resilient member, in order that when the handle top portion is pulled outwards from the main handle, against its incumbent spring, it is capable of being rotated from one locked rotational position to another in order that the moving handle can be locked against the main handle or alternately unlocked whereby the moving handle is free to rotate out to an open position or close as required in order to operate the snips, wire strippers or any other known operation pliers function.

13. A screwdriver comprising the screwdriver handle of any one of the preceding claims and a screwdriver shaft secured to said main frame.

14. The screwdriver of claim 13, comprising a retaining shaft bore for said screwdriver shaft, a spring recess, a top portion spring corresponding to the main handle top portion shaft, a retainer profile and cap, the said handle top further incorporates at least one open notch which in the first said top portion rotational position corresponds with the position of a catch within the distil or outer end of the moving handle, which allows the moving handle body to be swivelled out or operated back into the main handle body as required when the catch and notch are aligned and the catch is free to traverse within the notch profile, the handle top portion is retained in its open position by the main handle top portion locating projection located within the top portion open locking recess.

15. The apparatus of claim 14, whereas when the moving handle body requires to be locked in its closed position relative to the main handle body, the moving handle body is first closed against the main handle body, the handle top portion is then pulled from the main handle body against its closure spring enough to allow access to a further guide face between the open and closed locking recesses and rotated as required into the locking recess, the said catch on the outer end of the moving handle body now corresponding to a further locking face within the handle top portion thereby retaining the moving handle body locked against the main handle body, the handle top portion is retained in its closed position by the main handle top portion locating projection located within a closed locking recess.
